(19) United States
(12) Patent Application Publication
(10) Pub. No.: US 2006/0029913 A1
(43) Pub. Date: Feb. 9, 2006

(54) Alphabet based choreography method and system

(76) Inventor: John Alfieri, Wayne, NJ (US)

Correspondence Address: JOHN ALFIERI, P.O. BOX 3494, WAYNE, NJ, 07474-3494, US

(21) Appl. No.: 11/197,963

(22) Filed: Aug. 5, 2005

Related U.S. Application Data
(60) Provisional application No. 60/599,410, filed on Aug. 6, 2004.

(51) Int. Cl. G09B 5/00

(52) U.S. Cl. 434/169

(57) ABSTRACT

The present invention is directed to a system and method for creating choreography, comprising an input device for inputting alphanumeric characters and a processor for receiving the inputted alphanumeric characters. The processor performs the steps of associating a body movement with each character of the set of alphanumeric characters, and combining characters of the alphanumeric set of characters into one or more words to creating a textual representation of the choreography to be performed. The textual representation of the choreography and an image performing the choreography may be displayed on a display device.

### CROSS-REFERENCE TO RELATED APPLICATIONS

This application claims the benefit of provisional patent application Ser. No. 60/599,410, filed 2004 Aug. 6, by the present inventor, which is herein incorporated by reference.

### FIELD OF INVENTION

This invention relates to the field of dance fitness, specifically to a method and system for creating unique choreography.

### BACKGROUND OF INVENTION

In the United States, aerobics instructors must pass a nationally standardized certification course in order to teach aerobics classes at health clubs. This course addresses: muscle strengthening, cardiovascular conditioning and prepares instructors to design workouts. However, the course does nothing to ensure that the routines choreographed by instructors are inspiring, exciting or even interesting to the clientele the instructors will be hired to “pump up.” Yet, management in all health clubs relies on each of its aerobics instructors to choreograph exciting routines for every class an instructor is responsible for teaching.

Even though aerobics instructors are generally in tremendous physical shape and able to endure teaching class after class, one of the main disadvantages of the present system is that the majority of aerobics instructors just aren't dance or aerobics routine choreographers. Besides, most aerobics instructors teach aerobics part time, while also working full time jobs. They don't have the time needed to come up with new choreographed routines for each of their classes every week. So, many instructors fall into the rut of using the same routines over and over, again, which causes repeat customers to get stuck in classes, where the routines become a choreographed equivalent of hearing the same song played, over and over.

In the present day, the most widely practiced method of creating choreographed aerobics routines is, simply, the instructors themselves spending hour after hour, trudging through bits and pieces of dance steps they've seen or are learning, and combining them with steps they already know. They repeat the steps until the combinations are hammered into their heads. Then, practice the choreographed routines, gruelingly until memorized.

Further, after the memorized routines are used a few times in class, they are disregarded. Because instructors are expected to come up with new choreographed routines for their new classes the following week. Once new routines are created, these too, must also be practiced for hours until memorized, only to be disregarded after they, too have been used a few times in class. And the following week, the grueling cycle continues.

Further, if instructors learn too many routines, they risk forgetting or confusing steps while teaching classes.

Another disadvantage in the instructor's present day grind of finding new choreographed material is in the onslaught of choreographed routines sold on video and DVD, made by professional dancers and choreographers. Aerobics instructors don't purchase only one of these; but feeling at the mercy of forever having to come up with fresh choreography, they continue making these purchases throughout their entire careers. It becomes very costly, money-wise, as well as time-wise.

Further, no matter how many choreographed routines are purchased on DVD and memorized, after being used a couple of times in class, they too will have to be disregarded for new routines yet to be created.

Another deficiency in the present time becomes apparent when buddying instructors are compelled to meet off-work hours in an attempt to come up with new routines. This can take countless hours and very often yield non-original results. Further, many instructors put a high value on their off-work time, having families and full time job responsibilities to attend to.

It's not uncommon for aerobics instructors to take various dance classes on their own time to invite inspiration to create new routines. The down side is that after long periods of trying to create choreography, in this manner, it adds up financially and physically due to the grueling hours of rehearsal time. Further, sometimes instructors are able to come up with new choreography, and sometimes, no matter how hard they strain, instructors cannot translate the material being learned in dance classes to material for their own aerobics classes.

A small percentage of instructors opt to attend further-learning seminars, but the high cost of these day trips makes them the most expensive of all choreography fishing expeditions. Though rare, some higher-end health clubs pay or partially pay for its staff to attend these seminars. But this becomes expensive for the health club. Also, it is a time consuming, no-paying activity associated with work for the staff. Further, even if an instructor is able to mentally retain a new choreography routine learned at a seminar, the routine must be rehearsed until memorized. Only to be, within a week, just another worn out routine that's been gobbled up by a clientele hungering for new, exciting material to work out to. So, the instructor is thrust back into fishing for more fresh choreographed routines for next week.

Having to come up with new routine choreography weekly is the part of the job most aerobics instructors dread, but with no other options available at the present time, they continue the struggle to find new choreography for every class, every time they teach it.

The number of aerobics instructors at any given health club can be anywhere from ten to one hundred, depending on the size of the business. There are presently very wide inconsistencies in the quality of the choreographed routines used by each staff member within every health club. This poor standard of quality control seems to be accepted as an industry standard, and at this moment health club management seems helpless to change it.

In national-corporate-chain health clubs, managers are responsible for anywhere from forty to one hundred aerobics classes to be covered by instructors, weekly. The managers are constantly juggling full schedules of instructors, and always under pressure to fill gaps in classes when instructors call in sick, come in late, or quit. If an aerobics instructor on staff is loyal and dependable, whose only fault is stale choreographed routines, as long as no official complaints are made, many managers find it easy to overlook the instructor's boring choreography. The reason being, the manager is more likely to suffer in the short term from not having enough willing instructors to cover the holes in scheduled classes, than, in the long term for stale choreographed routines from a boring instructor. By the time the manager takes heed and confronts an instructor's mundane choreography, a staggering number of clients could have already become bored in classes and quietly dropped out.

There are those rare cases where an aerobics instructor happens to be a natural choreographer. However, most instructors, even the ones working for decades continue, unbeknownst to their clientele, to haphazardly hustle up and string together pieces of choreographed routines, cramming for their classes as they go along.

At the present time there is no teaching tool that affords management to supply each aerobics instructor in their employ with an easy to use, standardized method, that produces a teaching tool for instructors to create any one of hundreds of millions of new, original and interesting choreographed aerobics routines for all their classes. Without such a teaching tool, present day instructors continue trudging through, puzzling together, and hammering into their heads until memorized, new choreographed dance steps from videos, seminars, dance classes and one another.

Higher standards in choreographed aerobics routines is a vastly over-looked aspect in the health club industry compared to the more immediate aspects, such as increasing membership or the maintaining of day to day operations. But exciting aerobics classes filled with constantly changing material are exactly what attracts a percentage of perspective members to want to join a specific health club in the first place. If a health club's aerobics classes don't remain constantly new and interesting it hurts the reputation and eventually the earnings of that health club.

Accordingly, there is a long felt need in the field of dance fitness for an apparatus and methodology, revolutionary in nature, to overcome the above-mentioned deficiencies in the field. The apparatus and methodology may enable aerobic instructors to instantly create and perform choreographed aerobic routines that are constantly changing, exciting and inspiring. This apparatus and methodology may also enable aerobics instructor, whether working independently or employed by a health club, to create and instantly perform any one of hundreds of millions of choreographed routines.

### SUMMARY

The invention includes a method for creating choreography, comprising selecting an alphanumeric set of characters, selecting a body movement to associate with each character for the set of alphanumeric characters, combining characters of the alphanumeric set into one or more words to creating a textual representation of the choreography to be performed; and performing the choreography by executing each body movement associated with the textual representation of the choreography.

The inventions also includes a system for creating choreography, comprising an input device for inputting alphanumeric characters, a processor containing source code for receiving the inputted alphanumeric characters and performing the following steps: associating a body movement with each character of the set of alphanumeric characters and combining characters of the alphanumeric set of characters into one or more words to creating a textual representation of the choreography to be performed. The system may also comprise a display device for displaying the textual representation of the choreography and an image performing the choreography.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

FIG. 1 is an illustration a computer system implementing one embodiment in accordance with the present invention;

FIG. 2 is a flow chart of a method in accordance with the present invention; and

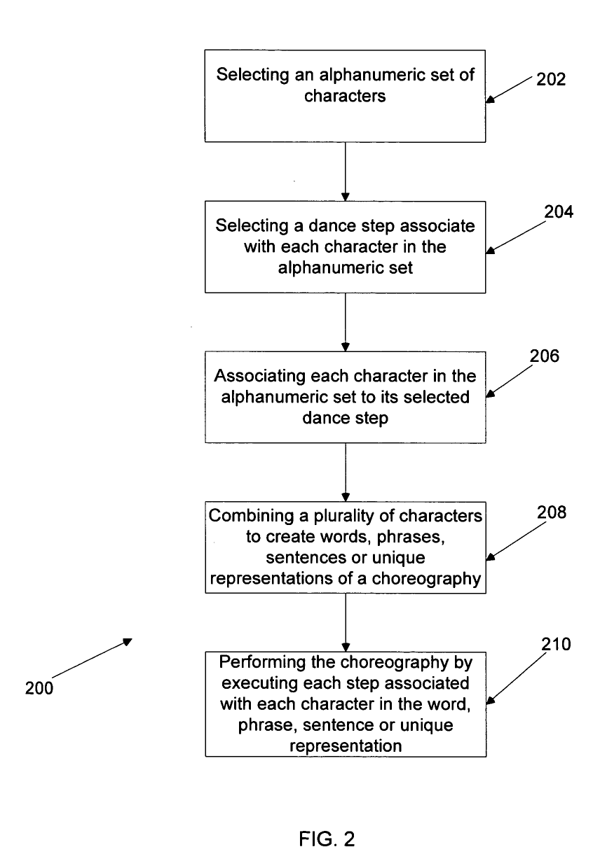

FIG. 3 is a flow chart of a second method in accordance with the present invention.

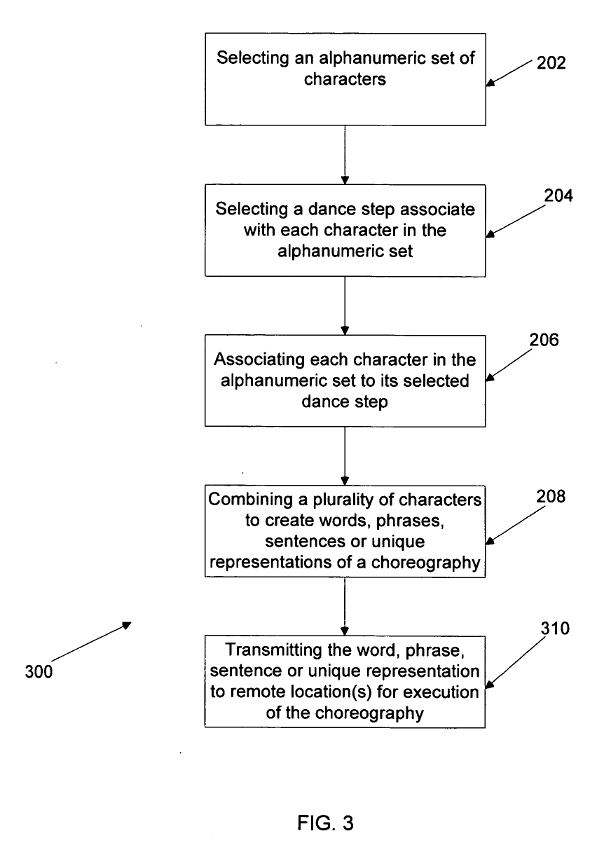

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

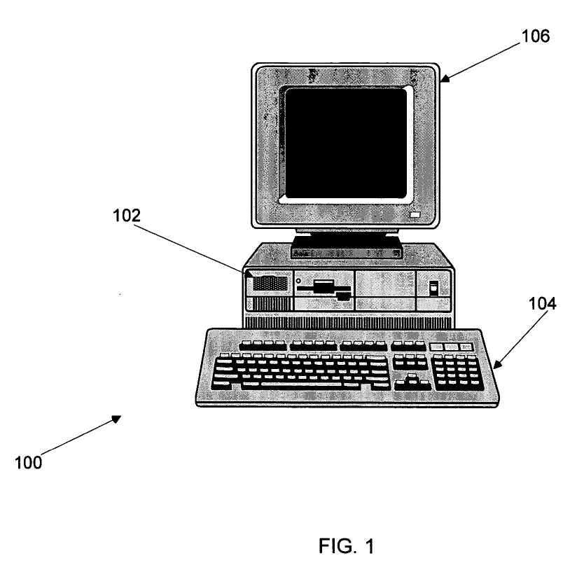

In one embodiment an apparatus may be implemented using computer system 110 (FIG. 1). Computer system 110 may be any one of many processing devices which are known to those of skill in the art. Computer system 110 may include software code 102, input device 104, and display device 106. Software code 102 may be an application program that, based on input from input device 104, enables computer system 110 to associate a dance step with an image of an aerobics instructor and display such image on display device 106.

For example, when a user enters the letter “A” into input device 104, computer system 110 may display the image of an aerobics instructor on display device 106, which performs a dance step associated with the letter “A.” Then, if the user enters the letter “B” or “C” into input device 104, computer system 110 may, similarly, display the image of an aerobics instructor on display device 106, which performs a dance step associated with the corresponding letter.

In one exemplary embodiment, for each letter of the alphabet input into input device 104, computer system 110, through software code 102, may display on display device 106 an aerobics instructor performing a dance step for each letter of the alphabet. Furthermore, for any combination of letters, words, or sentences that may be typed into input device 104, computer system 100 may create a textual representation of the choreography on display device 106 and display an image of an aerobics instructor performing the dance steps associated with the letter(s) comprising the textual representation of the choreography. The image of the aerobics instructor may perform each step associated with the textual representation, one step at a time, until the choreographed routine is complete. This process may allow the viewer to see how anyone of over a hundred million choreographed routines may be performed.

Any combination of letters, words, or sentences typed into input device 104 initiates software code 102 to produce a textual representation of the choreography to be performed by an image of the aerobics instructor on display device 106. In contrast to the present haphazard ways instructors are attempting to achieve new choreographic routines, which take hours to choreograph a single routine for their classes, with the present embodiment, instructors may easily create constantly changing, fresh and original choreographed aerobics routines.

In this embodiment, by connecting the twenty-six individual dance steps with the letters of the alphabet, which is the equivalent of memorizing one full aerobics routine, an instructor is enabled to perform and teach hundreds of millions of routines. Once the dance step is assigned to each of the twenty-six letters in the alphabet, the possibilities of choreography become as infinite as there are combination of letters forming words and combination of words forming sentences, lines of poetry, or compositions.

The above-described embodiment may be used by independent-individual instructors, individually owned health clubs, or anyone wishing to create unique choreography. With this embodiment, users would be enabled to create unlimited choreography for all the aerobics classes they teach. By having the ability to produce fresh, original, aerobics routines for every class they teach, users of this apparatus, in accordance with the present invention, will have a financial benefit over competitors who do not have access to the apparatus.

In another embodiment in accordance with the present invention, computer systems, such as computer system 100, may be connected via a computer network (not shown). National chains of health clubs may use this embodiment to standardize staffs of thousands of aerobics instructors with a standardized choreography-language. Management may transmit over the network a sentence or slogan that every aerobics instructor in every facility, nationally, would be able to follow.

Through on-going training classes in the use of this embodiment, users would spark great creativity and commodity among staff. Users would have a clear edge on their competitors whose instructors would not be able to create choreography as easily or endlessly. At the present time, no individually owned health club or corporate health club chain has a uniformed choreography system for its staff to easily access hundreds of millions of choreographed routines.

In another embodiment, in accordance with the present invention, a method 200 may be implemented to produce new, creative and original choreography. In stage 202 of method 200, an alphanumeric set of characters is selected. Then in stage 204 and 206, a dance step is chosen and assigned to each character in the alphanumeric set of characters. Preferable, each dance step chosen is a physical movement familiar by association (easy to mentally link to the associated character). An example of a physical movement familiar by association may be “Backward step” to the letter “B.” This would make the textual representation of the “Backward step” the letter “B”. Based on this example, when the letter “B” is read in a sentence representing the choreography to be performed, one would know the “Backward step” is to be performed.

The following are examples of movements that can be easily associated with each letter in the alphabet: A=Abridge step, B=Backward step, C=Crossover step, D=Diagonal step, E=Edge step, F=Flair step, G=Grapevine step, H=Hook step, I=Inward step, J=Jump step, K=Kick step, L=Lean step, M=Mountain step, N=Nations united step, O=Ouch “hot foot” step, P=Pulsate step, Q=Q “directional” step, R=Rise step, S=Shuffle step, T=Tap step, U=U-turn step, V=“V” step, X=“X” step, Y=Y “corkscrew” step, and Z=Zoom step.

Next in method 200, the plurality of characters may be combined to create words, phrases, sentences or unique representations of choreography to be performed. (Stage 208) The choreography may be performed by actually executing the dance steps or by displaying an image of an aerobics instructor performing the steps. (Stage 210) For example, an aerobics instructor may create a textual representation of choreography by writing the sentence “the sky is blue.” By using method 200, the list of steps defined would be: Tap step (associated with T)+Hook step (associated with H)+Edge step (associated with E)+Shuffle step (associated with S)+Kick step (associated with K)+Y “corkscrew” step (associated with Y)+Inner step (associated with I)+Shuffle step (associated with S)+Back step (associated with B)+Lean step (associated with L)+U-turn step (associated with U)+Edge step (associated with E).

Using method 200, choreography may be performed without memorizing the whole routine, simple, by referring to each move associated with the textual representation of the choreography. (Stage 210). For example, the choreography is performed by dancing each dance step associated with each letter, one letter at a time—spelling one word at a time, until all the letters of all the words in the sentence are performed. In this example, a choreographed routine is created by performing each dance step associated with each letter in “the sky is blue.”

One possible advantage of method 200 is that the final result of the choreography doesn't necessarily have to be known, because the choreography will unfold as each letter is translated into its assigned dance step and performed. Therefore, the choreographed routine is built by completely spelling out its textual representation.

Each step may be performed, preferably, though not necessarily within one measure of music, whether it be within the general 4/4 count, 8/8 count or any count created in the music. Choreography may be created to any type of music, including rock-n-roll, ballroom, country & western, Latin (Salsa, Rumba, Merengue, Samba,) big band swing, techno, rhythm & blues, jazz, club, hip-hop, classical, step, folk or modern.

In performing the choreography created by the embodiments, in accordance with the present invention, the choreography can be started on the left or right foot, and continue to be danced however the instructor sees fit. The first letter can be performed starting with the right foot, and the next letter can be performed starting on the left, or vice versa. As an alternative, all steps can be performed starting with the right foot, or all steps can be performed starting with the left foot. Using method 200, a user may begin and end the choreography on whichever foot is desired.

The method, in accordance with the present invention, will work no matter what dance steps are used. The placement of letters in front of—and in back of—the letter being performed can change the dance step associated with the middle letter, as opposed to that letter being performed by itself. This makes the choreography of a single letter change depending on what word or combinations of letters are being used.

In a further embodiment, a method 300 in accordance with the present invention is performed. Method 300 executes similar stages to stages 202-208 of method 200. However, once stage 208 is performed, the words, phrases, sentences or unique representations are transmitted to remote location(s) for the choreography to be performed. (Stage 310)

The foregoing description of the present invention has been presented for purposes of illustration and description. Furthermore, the description is not intended to limit the invention to the form disclosed herein. It should be noted that the same principles that are described herein could apply to other embodiments without departing from the scope of the present invention. Consequently variations and modifications commensurate with the above teachings, and the skill and knowledge of the relevant art are within the scope of the present invention. The embodiments described herein are further intended to explain the best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A method for creating choreography, comprising:
selecting an alphanumeric set of characters;
selecting a body movement to associate with each character for the set of alphanumeric characters;
combining characters of the alphanumeric set into one or more words to creating a textual representation of the choreography to be performed; and
performing the choreography by executing each body movement associated with the textual representation of the choreography.

2. The method of claim 1, wherein the characters of the alphanumeric set are combined to create one of sentences and phrases.

3. The method of claim 1, wherein performing the choreography includes displaying an image which performs the textual representation of the choreography.

4. The method of claim 1, wherein the numeric characters of the alphanumeric character set are used to create a numeric representation of the choreography to be performed.

5. The method of claim 1, wherein the combined characters that create the textual representation of the choreography are transmitted to remote location(s).

6. The method of claim 1, wherein the alphanumeric characters are associated with dance steps to create the choreography.

7. A computer-readable medium which stores a set of instructions which when executed performs a method for creating choreography, the method executed by the set of instructions comprises:
selecting an alphanumeric set of characters;
selecting a body movement to associate with each character for the set of alphanumeric characters;
combining characters of the alphanumeric set into one or more words to creating a textual representation of the choreography to be performed; and
performing the choreography by executing each body movement associated with the textual representation of the choreography.

8. The computer-readable medium of claim 7 further comprising executable instructions for combining characters of the alphanumeric set to create one of sentences and phrases.

9. The computer-readable medium of claim 7 further comprising executable instructions for performing the choreography by displaying an image that performs the textual representation of the choreography.

10. The computer-readable medium of claim 7 further comprising executable instructions to use the numeric characters of the alphanumeric character set to create a numeric representation of the choreography to be performed.

11. The computer-readable medium of claim 7 further comprising executable instructions to transmit the combined characters that create the textual representation of the choreography to remote location(s).

12. The computer-readable medium of claim 7, wherein the alphanumeric characters are associated with dance steps to create the choreography.

13. A system for creating choreography, comprising:
an input device for inputting alphanumeric characters;
a processor executing source code for receiving the inputted alphanumeric characters and performing the following steps:
associating a body movement with each character of the set of alphanumeric characters, and
combining characters of the alphanumeric set of characters into one or more words to creating a textual representation of the choreography to be performed; and,
a display device for displaying the textual representation of the choreography and an image performing the choreography.

14. The system of claim 13, wherein the characters of the alphanumeric character set are combined to create one of sentences and phrases.

15. The system of claim 13, wherein the numeric characters of the alphanumeric character set are used to create a numeric representation of the choreography to be performed.

16. The system of claim 13, wherein the combined characters that create the textual representation of the choreography are transmitted to remote location(s).

17. The system of claim 13, wherein the input device is one of a mouse and a keypad.

18. The system of claim 13, wherein the display device is one of an LCD and CRT computer monitor.

19. The system of claim 13, wherein alphanumeric characters are associated with dance steps to create the choreography.
